(19) United States
(12) Patent Application Publication
(10) Pub. No.: US 2024/0158297 A1
(43) Pub. Date: May 16, 2024

(54) Use of dry mineral clay as a contact desiccant for the drying and mineralization of green wood chips

(71) Applicant: Jeffrey E Darland, Tigard, OR (US)

(72) Inventor: Jeffrey E Darland, Tigard, OR (US)

(21) Appl. No.: 18/056,071

(22) Filed: Nov. 16, 2022

(51) Int. Cl. C04B 20/10; C04B 18/02; C04B 18/26; C04B 28/00

(52) U.S. Cl. CPC C04B 20/1074; C04B 18/021; C04B 18/26; C04B 28/006

(57) ABSTRACT

A method is provided for mineralizing green wood chips to render suitable for inclusion into a wide variety of cements for producing wood-cement composites. Green wood chips of high initial moisture content are coated in a dry powdered mineral clay material and allowed to cure under ambient environmental conditions. Upon disaggregation, the chips provide a useful means of increasing hygrothermal behavior, light-weighting, and carbon sequestration by incorporation into wood-cement composites.

### CROSS-REFERENCE TO RELATED APPLICATIONS/INCORPORATION BY REFERENCE

This patent application claims priority to, and claims benefit from U.S. Patent Application Ser. No. 63/282,049, filed on Nov. 22, 2021, and titled “The use of dry mineral clay as a contact desiccant for the drying and mineralization of green wood chips”, which is hereby incorporated herein by reference in its entirety.

### BACKGROUND

The present invention relates to a method for treating freshly-chipped, green wood in such a manner as to both desiccate and mineralize the material sufficiently to render suitable for inclusion into concrete and cement formulations as well as geopolymer systems.

It has long been known that there are advantages to composite building materials that utilize wood or other vegetative materials (straw, hemp, etc.). Benefits can include: improved hygrothermal management, costs, reduced embedded energy, light-weighting. More recently, this has also been viewed as a form of long-term carbon sequestration.

Fresh green wood is generally considered to be incompatible with cements, particularly Portland Cement, due to a combination of factors—wood sugars, terpenes and other volatiles, shrinking of wood during drying, and other factors. Consequently, when wood chips are used in cement applications they are treated in such a way to render them compatible, and this term is generally considered “mineralization”.

Wood-earth composites predate recorded history, and these generally can be considered a clay-vegetal blend, that may be stabilized through a variety of chemistries—typically lime, or other oxidized mineral, or ash. It is clear that these composites were intended to be part of a permanent structure. It is also the case that these applications always apply the clay materials either in a fully wet state, or else concurrent with water.

It is also known that the suitability of wood for cement composites can be improved through the addition of various stabilizing additives which can be metal oxides alone or in combination with acidic salts such as phosphates or sulfates. An example of this approach can be found in U.S. Pat. No. 6,464,775B2, where wood fibers are first saturated with water before addition of a combination of Portland Cement and a magnesium phosphate, and are specifically applied in combination with water. There are many other examples of wood treatment, and with the exception, perhaps of fungal or biotic modifications, all include the use of water to dissolve or distribute material.

An example of compatibilizing wood chips with a cement formulation utilizing a combination of clay and aluminum sulfate can be found in U.S. Pat. No. 5,019,170A, and more recently in EP 0 612 282 B1. In both cases, it is specifically required to start the process with wood already in an advanced state of drying (“U less than 40%”) and use an aluminum sulfate solution as a pretreatment. According to the applications, this is required to shock the cell walls closed prior to the addition of an aqueous clay. While further in the invention “green” wood is mentioned, it appears as though this is strictly referring to free moisture content, and not referring to the freshness of the wood, since at some point prior it had been dried to “U less than 40%”. In any event, process water is required, as the kaolin coating (or first of two kaolin coatings) is applied after the sulfate in the form of an emulsion.

Kaolin clay has long been used in combination with many different kinds of vegetal matter (including green chipped wood) for simple clay-slip insulation. This process requires the clay to be pre-mixed with water to make a dilute watery slip, which then is coated on the vegetal matter (which can include green wood chips, straw, or whatever vegetal is convenient to the construction). The wet material is then lightly compacted into place, for example as a wall, and allowed to dry prior to further covering. The purpose of this slip is to stick the material together and provide resistance to insects, and well as hygroscopic buffering. This material is intended for cast-in-place permanent construction purposes, and has never been considered as a precursor step to any other construction material than perhaps reuse as the same.

The consistency in the prior art is that clay materials, when applied to vegetal matter, are necessarily applied with an aqueous carrier. This, because the intent has always been to distribute the clay particles physically within a matrix, or to coat, and not to use the clays as an adsorptive desiccant and reactive means for removing or converting water, mobile, and volatile components from green wood chips.

For many reasons in-field processing can be desirable. A variety of equipment strategies already allow for the in-field production of classified wood chips. However, none of the prior art demonstrates a manufacturing process suitable for processing green wood directly into an aggregate which eliminates the need for process water, purified chemical additives, and/or artificial drying, and which can be easily moved from site-to-site in a manner requiring limited special equipment.

### BRIEF SUMMARY OF THE INVENTION

The objective of this invention is to provide a means for producing an aggregate suitable for inclusion into a wide variety of cement and concrete building products, such method suitable for directly processing green wood chips, and requiring no process water or artificial drying means. Furthermore, said process not requiring the use of synthetic chemicals or purified chemistries.

This objective is realized through the unexpected benefits of utilizing air-dry, powdered clays as a contact desiccant for green wood chips. The clay is applied by coating and fully encompassing the green wood chips in dry clay powder after chipping, and subsequently allowing the clay-wood chip blend to equilibrate with ambient conditions. After sufficient time, the wood chip-clay aggregate has “mineralized” (predominantly stabilized in both water and migratory chemicals), and this bulk material is easily separable and suitable for inclusion into a variety of cement and earth-cement formulations. Of particular suitability are natural building products which require the increased thermal resistance or hygroscopic buffering provided by both the clay and the wood particles.

There is no anticipated shelf life for this material, and the encasement of clay provides a significant reduction in direct fire risk, as compared with a traditional chip pile.

### BRIEF DESCRIPTION OF DRAWING

FIG. 1 schematically represents a process flow of a preferred embodiment of the current invention.

### DETAILED DESCRIPTION AND BEST MODE OF IMPLEMENTATION

When discussing clays, it is important to distinguish between a definition based on particle size, vs. a mineralogical description (e.g, layered phyllosilicates). For the purposes of this invention clay refers to the mineralogical definition, whether or not the macroscopic particle size is considered in the “clay size range”. Furthermore, it is important to distinguish between purified clay minerals vs the range of clays present in any one geological deposit. While the current invention will provide more than adequate results with artificially purified clay materials, it is most advantageous from a cost benefit to use a locally mined natural clay. In this sense, and for the purposes of this invention the mined clay is defined by the majority mineral type even though other clays or minerals may be present. For example, a “kaolinte clay” may contain amounts of illite and other minor clays.

While this invention works with all natural clays, including high-swelling clays, it is particularly advantageous to use clays with lower-swelling characteristics. If using water sorption as a method for measuring swelling potential, water sorption is preferably less than 200%, more preferably less than 150%. This would include kaolinite and illite clays, which are preferred.

Low-swelling kaolinite clays are most preferred for this invention. Such clays are widely available globally, and tend to have a natural particle size distribution with approximately 50% of the particles below 10 um, which is a preferred size distribution. As such, the preferred clays needed for this invention are readily available and require no unique or onerous additional modifications or process steps other than the conventional milling and screening steps to produce powdered clay.

It is similarly important to distinguish the simple act of drying (water removal), from the additional processes occurring within the wood clay mixture, which also serve to both remove or otherwise inactivate “wood sugars” and other undesirable components and provide increase compatibility cements and the wood surface (“mineralization”). For the purposes of this invention, the combined steps of drying and mineralization is considered “curing”.

Without being bound to theory, it is considered that in addition to simple drying through hygroscopic absorption of the clay and vapor equilibrium processes, additional benefits are gained through Bronsted and/or Lewis acid reaction sites which serve to facilitate reactions with wood sugars that render them more inert. It is known that clays such as kaolinite and montmorillonite can act as universal catalysts to some extent having both Bronsted and Lewis acid centers.

It is recognized that there are many ways to accelerate the drying process through processes such as: enhanced ambient (e.g. solar greenhouse), thermal, rf heat, and others, some of which may provide addition catalytic conversion opportunities utilizing the clay materials. While the invention considers those, one embodiment envisions the use of simple, low cost, low carbon infrastructure requiring no significant facilities or oversight during the curing process (field-drying). Another embodiment is the use of passive solar greenhouse drying for situations that are unable to dry conventionally to a desired moisture content or organic reactivity, for example, due to ambient temperature and humidity levels. Consequently, it is hypothesized that some reactions may occur between the wood sugars and these acid centers that either mineralize the sugars or otherwise render them into a more inert form.

Similarly, and without being bound to theory, it is speculated that not only does the clay serve to absorb and neutralize sugars and volatile components (e.g., terpenes) during the drying process, additional acid-base reactions continue to occur in the organic phase in the absence of free water, which otherwise render these compounds inert. The combination of these two is considered by this invention to be the “curing” process.

Several variables will affect the time required to reach a predominantly an equilibrium state. For example—moisture content, sugar content, volatiles, as well as the particulars of the individual clay. Packing strategy, encasing material (if any) and thickness play an important factor, since these values affect the mass transport processes. In practice, in-situ moisture measurements through the packed material can provide a good measurement of approach to equilibrium, and this can be related to desired moisture content at end of cure, but additional time may be required for the organic reactions to complete sufficiently (this depending on the final intended application as well). From a practical perspective, material packed properly can sit in the field, lightly-covered from the elements until sufficiently cured, which may take several months to a year or more depending on packing strategy, wood source, and ambient environmental conditions. Since ambient conditions will dictate greatly this rate, individual locations may need different cure times to reach the same result even with the same chip size.

While no restrictions are placed on the wood source, it should be recognized that wood species vary widely in available moisture content, wood sugars, compressive strength, and many other factors that will affect both the curing time and final end-use properties. For example, some species may contain higher levels of non-reducing sugars or otherwise volatile compounds such as terpenes (e.g., juniper, redcedar) and might require a longer cure time, or may ultimately not produce desired results. Preferred wood species are the softwood species. More preferably trees in the pine and fir families.

Moisture is present in green wood both as free water (liquid water or water vapor) or as bound water (held by intermolecular attraction within cell walls). It is also important to note that moisture content varies considerably not only between trees and species, but also within the wood content of a single tree (heartwood vs. sapwood). For the purposes of this invention, it is important that the chipped material have sufficient original free moisture content during the application of the dry, powdered clay to initiate the interaction with the clay particles and allow for aqueous diffusional processes. Consequently, when applying the clay mineral powder, the moisture content of the green wood chips must be above the fiber saturation point (approximately 30% for most wood) to ensure liquid water is present.

In practice, however, the moisture content should be considerably higher to achieve proper chip coverage, and to allow for aqueous diffusion processes to continue to occur during the mineralization process. It is useful, therefore, to consider the “Residual Free Moisture Content”, which is the percent retained of the initial free moisture content (M/C) at felling. An example will help clearly illustrate this concept:
Wood Properties: M/C at felling: 87% by weight, Fiber Saturation Point: 30% by weight
   M/C 87%=100% Residual Free Moisture
   M/C 30%=0% Residual Free Moisture
   M/C 75.6%=(75.6%−30%)/(87%−30%)=80% Residual Free Moisture

Insufficient moisture may result in inadequate surface coverage and insufficient clay on the surface to absorb and interact with the water and volatiles that will continue be emitted from the chip during the curing process, as diffusional processes will be abbreviated. Light surface re-wetting of chips that have partially over-dried in process due to in-field logistics and ambient conditions (but have remained above fiber saturation point) prior to dry clay application is considered in this application as consistent with the intent of this invention, even though it adds an additional step and complexity, and is not preferred.

For the purposes of this invention, it is preferable to have a bulk average of at least a 60% Residual Free Moisture Content. More preferably, Residual Free Moisture Content is 80% or greater.

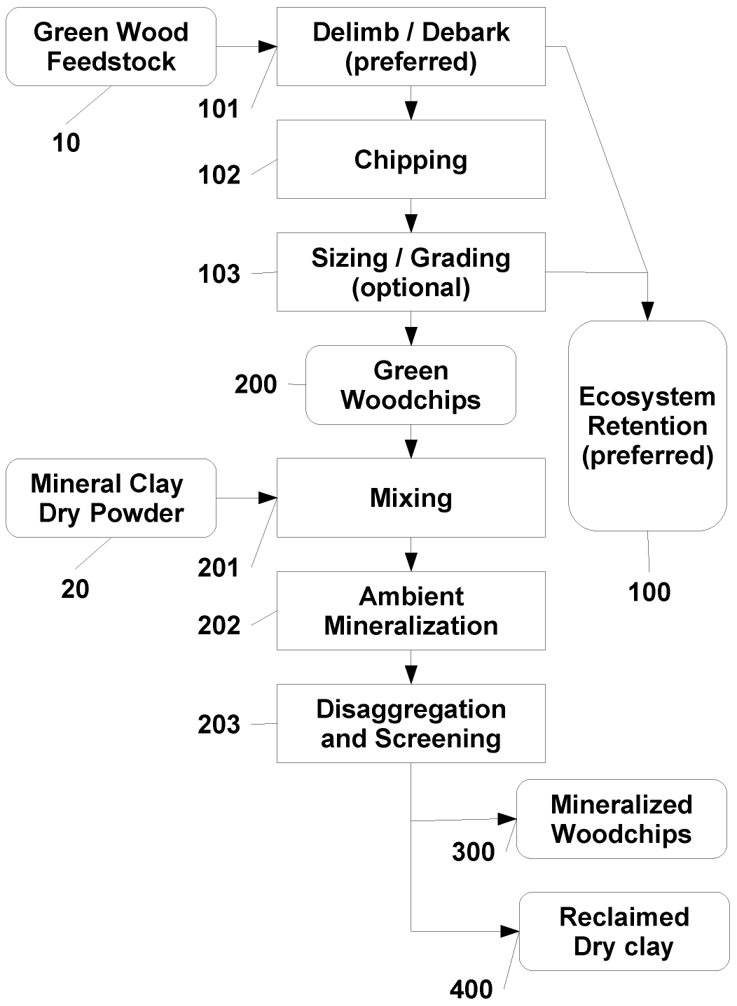

Referencing FIG. 1, the below example will clearly illustrate the process of the current invention.

Green wood feedstock (10) in the form of freshly felled trees are processed through conventional delimbing/debarking equipment (101). The removal of bark, needles, and small limbs simplifies product consistency—both morphology and moisture level. While the removed materials may be made to function under this invention, there are ecological reasons to leave these nutrient rich materials behind on site; and, their addition may add an additional level of complexity both in processing and final product options. In a preferred embodiment, these waste streams (100) are preferably retained locally.

Processed logs proceed through chipping (102) and on to sizing/grading (103) before producing Green Woodchips (200). Small- and large-scale equipment already exist in the industry to produce size-defined chipped wood, and nothing specific is required except the desired chip size and shape, which will be end application dependent. Hammer-milled, shredded, and/or wood excelsior is understood to be considered to be a form of woodchip for the purposes of this invention. Material screened out during sizing and grading is preferably retained locally for ecological benefit (100).

In order to ensure sufficient moisture is still present in the green woodchips (200), and to limit the physical degradation of the cellulose due to fungal activity, it is advantageous to mix (201) the chips with the dry clay mineral powder (20) preferably within 1 day, most preferably within 1 hour, most preferably within minutes. An exemplary residual free moisture content of the chips would be 80% or greater, but it is more important that the surface be actively transporting water sufficiently to coat the chips in a sufficient coating of dry clay, so minimum water content requirements will vary depending on the wood species, and chip morphology. Most preferable is to proceed immediately from grading (103) to the dry coating mixing process (201).

During the mixing process, sufficient dry mineral clay (20) is added to fully coat the wood chips in clay, plus an additional amount required for packing. This excess material is to facilitate the packing to allow for all chips to be fully surrounded by clay with minimal voids and bridging when packed for drying, and this will depend on the shape and size of the chips and the packing strategy for curing. When packed for ambient curing (202), chips should be fully encased in dry clay, with minimal bridging or air pockets.

A plurality of mixing options exist, both batch and continuous, which are suitable for blending fresh wood chips with the dry clay. Rotary batch drums may be suitable for smaller throughput. Continuous mixing processes are preferred, and these can be sized concurrently with the chipping process. Various commercially available mixing systems exist, and any will suffice so long as sufficient mixing and coating is obtained without damaging the structure of the wood chips. A preferred option is a continuous paddle mixer.

In addition to the dry clay material (20), it may also be advantageous for certain end-use applications to add additional materials to provide for chemical and/or physical modifications. These materials may be incorporated into the clay material matrix and/or applied immediately prior to application of the clay material. These applications may include, for example the co-addition or pre-application of a sulfate or chloride salt of calcium, magnesium, or aluminum, such salts being applied in their free flowing anhydrous or hydrous forms, requiring no additional water. While phosphate salts may also be added, these may end up being sequestered from ecological use, and therefore are not preferred.

Additionally, non-mineral materials may be also be incorporated with the clay material depending on the ultimate end-use of the product, and this is considered consistent with the current invention. For example, inclusion of biochar concurrent with the clay may facilitate vapor transport and accelerate the attainment of moisture equilibrium and additionally provide for local sorption of mobile organic phases for accelerated localized microbial degradation of wood sugars.

The combined woodchip-clay mixture is left to equilibrate to ambient conditions in a process referred to as “ambient mineralization” (202). During this stage, the clay wood chip mixture is allowed to naturally dry and react through surface evaporation and equilibrium processes to predominantly an equilibrium state, and several variables will affect this rate. For example—moisture content, sugar content, volatiles, as well as the particulars of the individual clay. Packing strategy, encasing material (if any) and thickness play an important factor, since these values affect the mass transport processes. In practice, in-situ moisture measurements through the packed material can provide a good measurement of approach to equilibrium, and this can be related to desired moisture content at end of cure, but additional time may be required for the organic reactions to complete sufficiently (this depending on the final intended application as well). From a practical perspective, material packed properly can sit in the field, lightly-covered from the elements until sufficiently cured, which may take several months to a year or more depending on packing strategy, wood source, and ambient environmental conditions. Since ambient conditions will dictate greatly this rate, individual locations may need different cure times to reach the same result even with the same chip size. There is no anticipated shelf life for this material if kept from direct water contact, and the encasement of clay provides a significant reduction in direct fire risk, as compared with a traditional chip pile.

It is recognized that there are many ways to accelerate the drying and curing process through processes such as: enhanced ambient (e.g. solar greenhouse), thermal, rf heat, and others, some of which may provide addition catalytic conversion opportunities utilizing the clay materials. While the invention considers those, one embodiment envisions the use of simple, low cost, low carbon infrastructure requiring no significant facilities or oversight during the curing process (in-field drying). Another embodiment is the use of passive solar greenhouse drying for situations that are unable to dry conventionally to a desired moisture content or organic reactivity, for example, due to ambient temperature and humidity levels.

Once the wood chip mixture has fully mineralized, the bulk material can now be easily disaggregated and screened (203) to separate into individually mineralized woodchips (300) and residual reclaimed dry clay (400).

Mineralized woodchips (300) are now suitable for inclusion into cement and geopolymer formulations,

Reclaimed dry clay (400) can be reutilized in a subsequent coating process, or else this material can be repurposed into many adjacent natural building materials requiring kaolin, for example lime-clay plasters, or material for clay-slip insulation using wood chips or other vegetal matter such as straw, hemp, etc. In such a way, this process can be close to zero waste both in the forest in converting usable wood to a mineralized aggregate, and also at the secondary stage of separation of the chips from the excess clay—which could occur at the woodlot, an intermediate processing facility, or even the production site where the material is to be used.

I claim:

1. A method for producing a wood chip-clay aggregate comprising:
coating green wood chips with a dry clay mineral powder, allowing the chips to remain encased in the clay matrix until equilibrium with ambient conditions have been substantially reached, and subsequently separating into individualized aggregate particles.

2. The method of claim 1, wherein the wood chips retain 60% or more of the initial free water content when coated with dry clay mineral powder.

3. The method of claim 2, wherein the wood chips retain 80% or more of the initial free water content.

4. The method of claim 1, wherein a sulfate or chloride salt of calcium, magnesium, or aluminum is added prior to or in combination with the dry mineral clay, said salt being in anhydrous or hydrous form.

5. The method of claim 1, wherein the clay mineral has a water sorption capacity of less than 200%.

6. The method of claim 5, wherein the clay mineral has a water sorption capacity of less than 150%.

7. The method of claim 1, wherein the clay mineral is predominantly a kaolin clay.

8. A wood clay aggregate made according to the process of claim 1.

9. A cementitious mix comprising a wood clay aggregate made according to the process of claim 1.
